(19) United States
(12) Patent Application Publication
(10) Pub. No.: US 2008/0052271 A1
(43) Pub. Date: Feb. 28, 2008

(54) Method To Converge A Plurality Of SQL Statements Into SQL Skeletons For Enhanced Database Performance Analysis And Tuning

(76) Inventor: Eric Lam, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/467,544

(22) Filed: Aug. 26, 2006

(51) Int. Cl. G06F 17/30

(52) U.S. Cl. 707/3

(57) ABSTRACT

This present invention is a method for converging a plurality of SQL statements into SQL skeletons to enhance database performance analysis and tuning for identifying the most influential SQL skeletons for databases on an RDBMS platform dependent on different standards. In this present invention, the SQL Normalization technique is combined with the accumulation of statistical information, which includes primarily the frequency, along with the cost and number of rows returned by the SQL skeletons. SQL normalization and collection of statistical data are thus the two principal constituents of SQL Convergence. This simple methodology can then be extended to meet various needs depending on the requirements of the RDBMS and the DBA's tuning priorities.

### FIELD OF THE INVENTION

The present invention is about database performance analysis and tuning, and more particularly, a method for converging a plurality of SQL statements into SQL skeletons to enhance database performance analysis and tuning by identifying the most influential SQL skeleton for databases on an RDBMS platform.

### BACKGROUND OF THE INVENTION

A relational database management system (RDBMS) is a database management system (DBMS) that is based on the relational model and stores data in the form of related tables. It presents the data to the user as relations and provides relational operators to manipulate the data in tabular form. Informix, DB2, Oracle, and Microsoft SQL Server are examples of popularly used relational database management systems.

SQL (Structured Query Language) is the most popular database sublanguage used to create, modify, retrieve and manipulate data from relational database management systems. The SQL-92 standard was developed by the INCITS X3H2 committee and has been designed to be a standard for RDBMS.

Relational databases in use today contain huge collections of stored data records. These could be as varied as sales transactions, lists of product stock, customer and account information, geographical data, medical history records, and so on. The sheer volume of so much data requires efficient, speedy, and optimized handling.

The critical performance factor for the end users is the response time after a request data command is sent. The DBAs (Database administrators) and application developers have to keep this response time at a minimum. However, in a typical user scenario, an end user typically experiences longer than desirable response times. The database system is always targeted as the source of response and/or performance problem. With increase in database operations due to increasing business demands, the number of SQL executions increases and slows down the response times for end users.

For the DBAs, on the other hand, the key factors are effective RDBMS configurations and the efficiency of SQL statements to handle maximum load by the server's CPU power. Thus, in a typical RDBMS scenario, the DBA experiences drains on system resources as the system cannot sustain the load generated by application requests. Consequently, the response time for end users suffers.

Poor response times and heavy database load can be caused due to bottlenecks at various levels, such as the network, web server, application server, or the database itself. However, most performance problems are due to the SQL executions that are embedded in application code, which fail to execute efficiently when accessing data. Out-of-date database settings such as incomplete database system statistics or missing table indexing are some of the critical reasons why the SQL statements are executed inefficiently. But the primary cause for this inefficiency is the fact that the SQL statements are poorly written and improperly tuned, causing consumption of excessive memory, disk I/O, and CPU power.

It is thus the DBA's responsibility to investigate the cost-intensive SQL statements that are causing poor performance. Unfortunately, the DBA can only control the RDBMS and has no capacity to evaluate application codes. In order to resolve the database performance problems, the DBA requires complete statistical information about the SQL statements being executed. This includes the SQL statement itself and its runtime, system resource cost of running the SQL statement, frequency of occurrence, number of resultant rows returned, and access methods such as sequential scanning. Any or all of these performance factors can be used to analyze the SQL statement. However, most RDBMS products that are available today are not equipped to provide this information. Even if some tracing or debugging data can be obtained through conventional tracing tools bundled with the RDBMS, the tracing task imposes an additional load on the database and fails to provide comprehensive statistical information.

In the commercial RDBMS market, a number of tools have been developed in the past for resolving database server performance problems and conducting performance tuning. The most prominent of these tools and their methodologies are listed below.
SQL trace: SQL Profiler is one of the standard suites of client tools that are distributed with Microsoft SQL Server 2000 and can be used to trace the actual SQL sessions. The SQL Profiler is a powerful tool for helping identify SQL Server performance problems, but it is not a tool for the beginner. Essentially, it allows the DBA to capture the communications between the application and SQL Server. The actual capturing of data is a straightforward process; however it can sometimes be difficult for a novice DBA to interpret the captured data and then solve the problem. Most importantly, SQL Profiler only traces a specific SQL statement at a time and is thus difficult to use for complex data systems.
Analysis of SQL logs: IBM's DB2 Log Analysis Tool allows the monitoring of data changes by automatically building reports of changes that are made to database tables. The tool enables storage of information on tables for future reference, generation of customized output reports, and the ability to automatically select the most efficient way to run reports.
SQL monitoring: IBM's Query Monitor for DB2 relies on SQL monitoring for identifying potential performance problems and keeping resource overuse in check. The tool gathers SQL monitoring information and uses drill-down analysis of resources into query activity, in both current and historical views. This technique provides ways to view execution paths of SQL statements as well as invoking the SQL Performance Analyzer when a problematic SQL statement is detected. The tool thus collects vast amounts of historical SQL data without any categorization or classification.

In addition to the tools mentioned previously, BMC Software provides tools such as SQL Explorer, SQL Performance, and SQL BackTrack that collect SQL activity at high speed, simulate SQL queries to evaluate cost, intelligently kill queries for runaway processes, and suggest SQL optimizations. These tools enable DBAs to detect the most expensive SQL statements, make tuning recommendations, and quickly pinpoint resource-consuming SQL statements.

Unfortunately, in spite of their advantages, all the tools available today offer only a partial solution to the problem of SQL performance tuning and suffer from some major drawbacks:
Focus on a specific SQL statement: Many diagnostic tools focus on a specific SQL statement at a time. This technique is seldom useful in catching the most influential SQL statement from a plurality of SQL statements.
Vast tracing data: Many diagnostic tools display huge amounts of tracing data that is not easily interpreted by any DBA. For large enterprise databases that handle millions of transactions per day, even the best analysis tool generates such huge quantities of diagnostic data that it is practically impossible to analyze the data. The problem becomes much more severe when the diagnostic data consists of a large number of SQL statements that are highly similar to each other. The limited filtering functions can only partially filter out unrelated SQL statements. In such a scenario, it is a tedious task to scan through the highly similar SQL statements and locate the problematic statements.
Lack of statistical classification: Many analytical tools use the RDBMS log files to retrieve information. Due to this technique, the tools themselves consume too many system resources and they usually focus only on a specific instance of a SQL statement.
Monitoring overhead: Most database monitoring tools themselves cause an additional drain on the system resources. A monitoring overhead on the production server can cause a substantial increase in the operating cost.

Thus, none of these tools identify SQL performance problems in the most efficient manner. Since an enormous number of similar SQL statements can be executed in a single timeframe, it is virtually impossible to debug each and every one of them or to fine-tune their performance. Finding the true problematic SQL statement can be equivalent to looking for a needle in a haystack and requires high-level database expertise. The need for a simplistic approach to alleviate the task of locating and solving SQL performance problems has been highly desirable. This has eventually led to the development of the SQL Convergence technology.

A reference in this application is U.S. Pat. No. 5,548,646 (the '646 patent), Database performance monitoring method and tool. The prior art provides a method and system for monitoring the process performance of a database that accepts and records SQL statements and that records the status of a session of use of the database.

However, the '646 patent mainly focuses on calculation of execution time for individual SQL statements. In this, it is substantially different from the SQL Convergence in the present patent application that focuses on how to capture the most influential SQL statements.

For most performance tuning situations, the challenge is not how to tune a single specific SQL statement or instance. The real challenge is to pinpoint and locate all the SQL statements that are most influential in impacting overall database performance.

### SUMMARY OF THE INVENTION

The present invention called SQL Convergence provides the most effective way to identify the most influential SQL skeletons since they play a critical role in capturing SQL bottlenecks that cause SQL performance problems. This is mainly achieved by removing the variable strings from SQL statements and accumulating the performance factors for these SQL statements. The most influential SQL skeletons are those selected from the accumulated number of the plurality of SQL skeletons and have the maximum frequency of occurrence, which is the primary selection factor. Alternatively, a plurality of the other performance factors may be used to select the most influential SQL skeletons.

It is believed that Pareto's Principle or the 80/20 Rule is fully applicable to the spirit of the technique. In the database world, it is commonly believed that 80 percent of the overall database performance is determined by 20 percent or less of all SQL statements, namely the most influential SQL statements. It is therefore possible to achieve a huge performance improvement when a small number (20 percent) of the most critical SQL statements is properly tuned. It thus becomes necessary to develop a methodology for the identification of these influential SQL statements without requiring the DBA to browse through application source code.

To identify the most influential statements, the present invention introduces a new concept named the SQL skeleton which is a SQL statement without the variable strings and is obtained through normalization of the SQL statement. Based on the SQL skeleton, accumulated performance factors highlight the most influential SQL statement through statistical analysis.

The present invention also introduces two new concepts for fast comparison of SQL skeleton strings, namely the Unique Signature Identifier (USI) and the Signature Container (SC). A Unique Signature Identifier (USI) is a singular numeric value used to identify a SQL skeleton and distinguish it from other similar SQL skeletons. Each SQL skeleton can thus be uniquely identified by its own USI. The preferred embodiment of the invention uses a hashing algorithm to compute the hash code, which is then assigned as the USI to a SQL skeleton. The hash code, being a numeral, takes up much less space for storage than the SQL skeleton itself. It is also easier to compare numeric values instead of lengthy SQL skeletons strings. USIs can also be implemented in the form of unique skeleton strings or bitmaps, in addition to hash codes. A Signature Container (SC) is a data structure that contains a listing of all Unique Signature Identifiers and maps the SQL skeletons to their corresponding USIs. The SC is used to store and retrieve USIs for identifying SQL skeletons. This structure thus provides an efficient and speedy technique to store SQL skeletons in the form of their USIs. The preferred embodiment of the invention uses a hashing list to serve as a container for the USIs in the form of hash codes. The SCs can be implemented as lists, queues, trees, arrays, tables, graphs, sets, or other data structures in the computer technology.

In the present invention, SQL normalization and collection of statistical data are thus the two principal constituents of SQL Convergence. The SQL performance analysis and tuning is now based on the meaningful SQL skeleton instead of individual SQL statements by extraction and tuning of the most influential SQL statements. The SQL Normalization is combined with the accumulation of statistical information, which primarily, is the frequency of occurrence of the SQL statement. In addition to the primary selection factor, a plurality of secondary performance factors such as execution cost, number of rows returned, access methods, and so on are also used to highlight influential SQL statements. This simple methodology can then be extended to meet various needs depending on the requirements of the DBMS and the DBA's tuning priorities.

A number of alternative embodiments of this invention are possible by using different combinations of a plurality of performance factors for distinguishing critical SQL statements. SQL execution cost, number of rows returned, table access methods are examples of the performance factors that can be used effectively. These may vary depending on the RDBMS and the selected embodiment of the invention. A possible extended application for this invention entails using the SQL skeletons to analyze busy tables and SQL bottlenecks. For instance, a table being accessed by a plurality of SQL statements with high sequential scanning can be an ideal candidate for refining the table indexes or for complete physical reorganization. Alternatively, a plurality of SQL skeletons with high frequency and high cost can be interpreted as a need for rewriting the SQL.

The objective of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a schematic diagram of the preferred embodiment.

FIG. 2 is a brief flowchart of SQL Convergence according to the preferred embodiment.

FIG. 3 is a flowchart of SQL Normalization according to the preferred embodiment.

FIG. 4 is a table illustrating the convergence of a plurality of similar SQL statements into a single SQL skeleton according to the preferred embodiment.

FIG. 5 is a detailed flowchart of SQL Convergence of the preferred embodiment.

FIG. 6 is a schematic sample report of the preferred embodiment.

### DETAILED DESCRIPTION OF THE INVENTION

Database operation consists of a long stream of thousands of SQL executions, with the number of SQL executions increasing in direct proportion to the complexity of the database system. Each SQL statement might take a few seconds to a few hours to complete execution. The efficiency of each SQL execution affects the overall database operation and a majority of database performance issues are due to improperly tuned SQL statements and execution. DBAs must ensure continuously running database systems with optimal performance, while finding solutions for performance problems.

SQL performance tuning is one of the primary responsibilities for the DBA. Properly tuned SQL statements that are executed efficiently can offer substantial improvements in database performance. SQL tuning involves analysis and diagnostics of SQL statements and their execution. This includes tracing the SQL session, analyzing the execution path, and evaluating the operation cost to the RDBMS. The key to SQL tuning is pinpointing SQL statements that are a drain on resources and improving their execution.

At the same time, diagnostic cost, which is the time required to diagnose problems and calculate performance metrics, is equally significant. The process of identifying resource-draining SQL statements must not impose an additional load that is more than 5% of the overall system resources.

The following core factors are crucial in identifying the most influential SQL statements that require tuning:

Primary Factor
Frequency: SQL statements that are executed repeatedly also indicate repeated usage of critical system resources. Even a minor improvement in a specific frequently repeated SQL statement can dramatically improve the overall database operation due to its repeatability.

Secondary Factors:
Cost: The cost of a SQL statement is the average time consumed during execution. A high cost of execution represents a high drain on system resources.
Number of Rows Returned: A specific SQL statement usually returns one or many rows as a result of the query.
Occurrence of Sequential Scan: Sequential scanning is a rudimentary method to access data. It causes the RDBMS to sequentially scan data blocks and might only retrieve a small portion of the total data scanned. The method is only suitable for small quantities of data. When accessing large quantities of data, the method uses up system resources with very low hit rate. After identifying SQL statements that perform inefficient sequential scans, performance may be improved by adding indexes to specific columns for the tables.

The preferred embodiment uses the primary performance factor (frequency) for highlighting influential SQL statements. The secondary performance factors are also used in a similar fashion for analysis and diagnostics.

However, identifying SQL statements that are resource drains is not a simple task in a real-world RDBMS that performs millions of SQL executions in a day. This proposal discusses a lightweight technique to extract the top resource-draining SQL statements patterns that are critical in terms of cost and frequency, in a non-intrusive fashion.

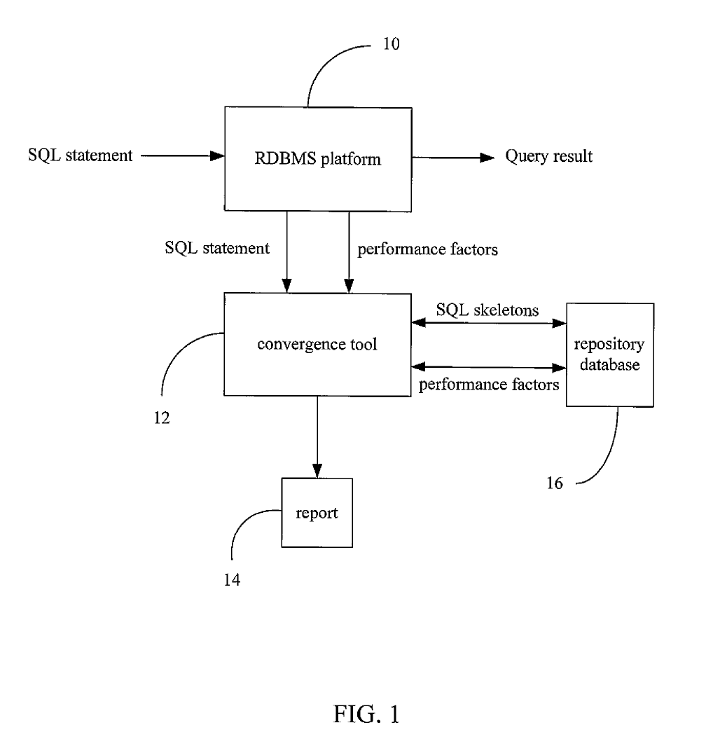

Refer to FIG. 1, which is a schematic diagram of the preferred embodiment according to the invention. The convergence tool 12 is applied to the RDBMS platform 10 which generates the query result in response to the given SQL statement. The convergence tool captures the SQL statement and performance factors from the RDBMS platform 10 and generates the SQL skeleton by stripping out the variable strings from the SQL statement. The repository database 16 stores the SQL skeleton and the performance factors from the convergence tool 12. The convergence tool 12 generates the report 14 based on the SQL skeletons and corresponding performance factors, stored in the repository database 16. The performance factors in this case, are comprised of the frequency of the SQL statement, execution cost, and the number of rows returned.

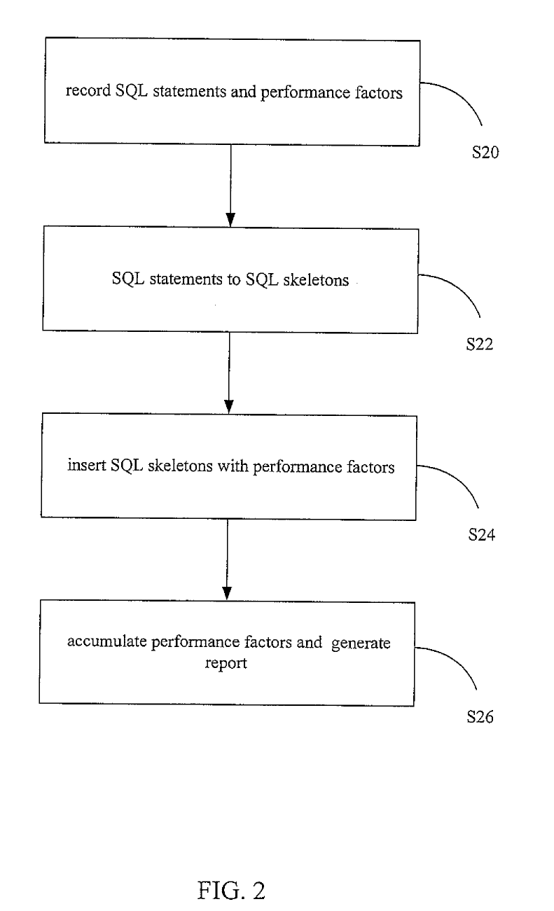

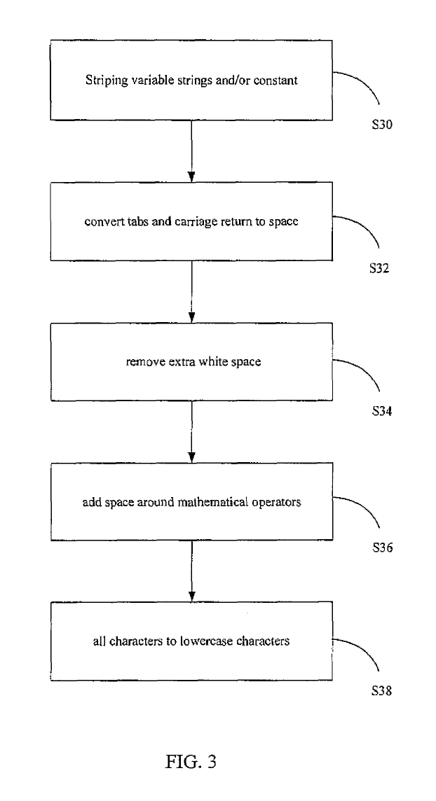

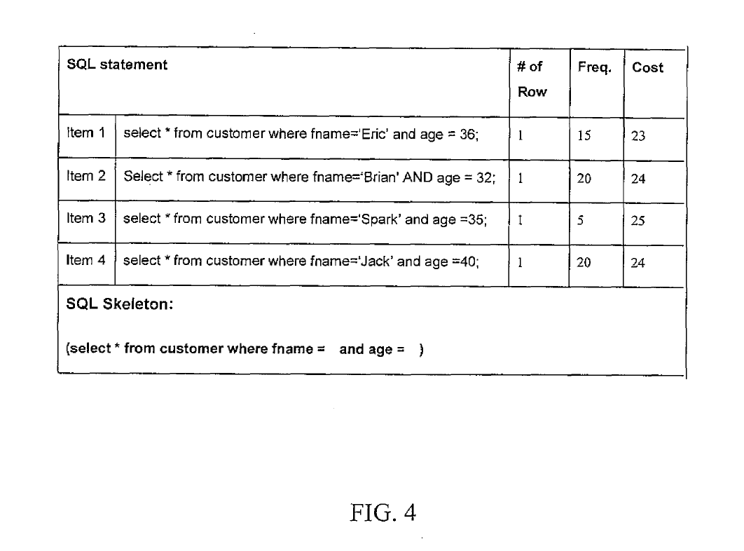

In the convergence tool 12, the captured SQL statements are normalized to extract SQL skeletons corresponding to each SQL statement by mainly stripping the variable strings from SQL statement, as shown in FIGS. 3 and 4. As shown in FIG. 2, the SQL Convergence Technology used in the convergence tool 12 aims to simplify said task of pinpointing expensive, resource-intensive SQL statements. The principle of this technology is based on the premise that similar SQL statements should be processed and identified by a SQL skeleton group instead of as a vast number of individual SQL statements. Such SQL statements can thus be categorized into generic SQL skeleton groups and analyzed for diagnostic purposes.

Refer to FIG. 2, which is a brief flowchart of SQL Convergence of the preferred embodiment according to the invention. First, go to step S20.
S20: record a plurality of SQL statements containing a plurality of variable strings and a plurality of performance factors from the DBMS platform 10 at predetermined time intervals;
S22: normalize the plurality of SQL statements to extract the plurality of SQL skeletons corresponding to each SQL statement;
S24: insert the plurality of SQL skeletons with the corresponding performance factors in a repository database 16; and
S26: accumulate the values of the plurality of performance factors corresponding to each SQL skeleton from the repository database 16 and generate a report 14 containing a listing of each SQL skeleton with the plurality of accumulated performance factors.

In one preferred embodiment, at the S20 step, SQL statements and their performance factors are captured from the memory of the RDBMS platform 10 non-intrusively at configurable time intervals, for example every 60 seconds, with little overhead to RDBMS operation. SQL statements are sampled at a certain time interval that can be set as required and stored in a separate repository for diagnostic evaluation.

Refer to FIG. 3, FIG. 3 is a flowchart of SQL Normalization of the preferred embodiment according to the invention. FIG. 3 is the flowchart for step S22 included in FIG. 2. First go to step S30.

The technology uses normalization techniques to construct the SQL skeleton by removing all variable strings, white space, and carriage return characters, and converting commands to lower case letters from the SQL statements, as shown in FIG. 4. This generic SQL skeleton is recorded in a repository database 16 and its performance factors including frequency, cost, and number of rows returned are accumulated in the database 16 as shown for FIG. 2. This categorizing technique essentially narrows down the scope of the diagnostic data for easy analysis by taking advantage of the repeating nature of similar SQL statements.

In one preferred embodiment, at the S30 step, each SQL statement is parsed and the variable string and/or constant are stripped out to construct a generic SQL statement skeleton. For example, in the SQL statement of item 2 included in FIG. 4 (“Select * from customer where fname=‘Brian’ AND age=32”), the variables ‘Brian’ and 32 are removed from the SQL statement. After removing variable strings and/or constants, the processes from step S32 to step S38 are performed by converting all letters to lowercase, ignoring white spaces (spaces and tabs), and adding space around mathematical operators. These steps are to normalize a plurality of SQL statements into SQL skeletons.

After normalizing a plurality of SQL statements into SQL skeletons, the SQL skeletons with their corresponding performance factors are inserted into the repository database 16 at step S24 included in the FIG. 2. Although the convergence tool 12 can judge whether the current SQL skeleton is present in the repository database 16 based on the string format of the SQL skeleton at step S26 included in the FIG. 2, it is however, inefficient to compare the current SQL skeleton with each SQL skeleton stored in the repository database 16 using the string for comparison.

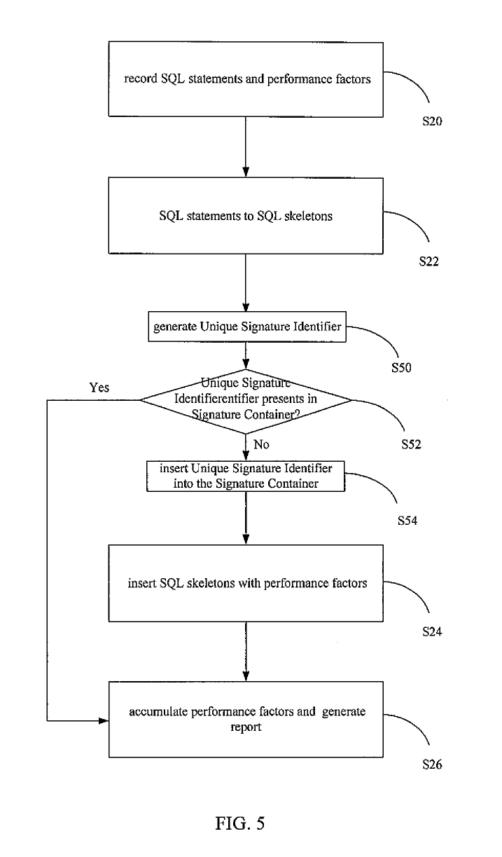

Refer to FIG. 5, FIG. 5 is a flowchart of SQL Convergence of the preferred embodiment according to the invention. FIG. 5 is a more complete embodiment than the flowchart of FIG. 2. In the SQL Convergence in the FIG. 5, the more effective method of comparing the Unique Signature Identifier (for example, a hash code) of the current SQL skeleton with the IDs stored in the repository database 16, is used.

After finishing step S20 to step S22 using the same method as described previously for FIG. 2, the convergence tool 12 generates a Unique Signature Identifier for each of the plurality of SQL skeletons, as shown in step S50. Then, the repository database 16 is searched for the ID. One of the following two actions is taken:
If the calculated Unique Signature Identifier has a match in the existing Signature Container (for example, a hash table/list) at step S52, accumulate the performance factors (cost, the number of returned rows, and the frequency) into the repository database 16 at step S26.
If the Unique Signature Identifier is new (that is, does not yet exist in the Signature Container) at step S52, insert the ID into the Signature Container at step S54. Insert the corresponding SQL skeleton entry along with the performance factors in the repository database 16 at step S24.

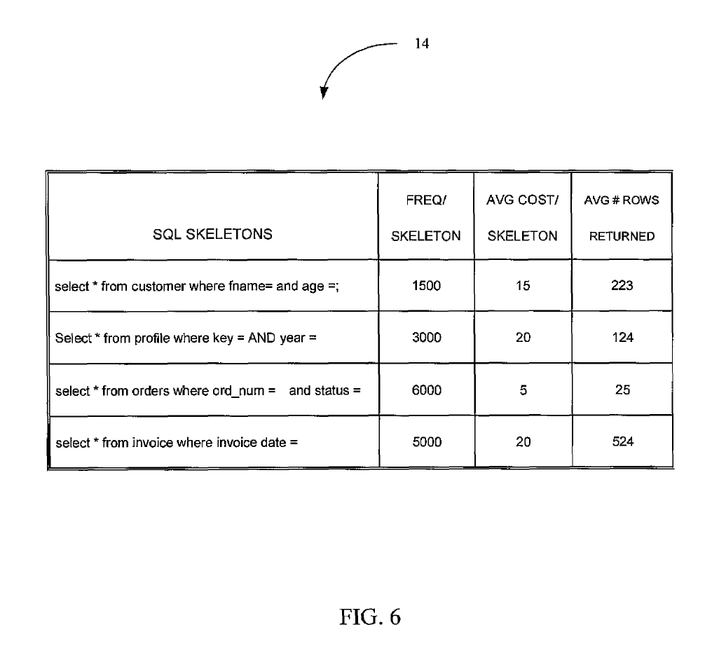

Refer to FIG. 6, FIG. 6 is a schematic sample report of the preferred embodiment according to the invention. After finishing step S24, step S26 is taken to accumulate the plurality of performance factors corresponding to each SQL skeleton from the repository database 16 and generate a report 14 containing a list of each SQL skeleton with the plurality of accumulated performance factors, as shown in FIG. 6.

The report 14 comprises of the SQL skeleton along with the accumulated performance factors selected from the accumulated number of the plurality of SQL skeletons, namely the occurrence per SQL skeleton or (frequency), the average system resource cost per SQL skeleton, and the average of the number of rows returned per SQL skeleton.

With the report 14, DBAs can identify the most influential SQL statements through the above statistical analysis. For example, the most influential SQL skeleton is the one selected from the accumulated number of the plurality of SQL skeletons with the maximum frequency of occurrence. Alternate embodiments may use a different performance factor to select the most influential SQL skeleton.

The present invention is to provide the most effective way to identify the most influential SQL statements that run for a specific period of time on a RDBMS platform. The principle of this technique is based on the premise that similar SQL statements should be processed and identified through groups instead of as a vast number of individual SQL statements. To identify the most influential statements, the present invention introduces a new concept named SQL skeleton regarding the analysis of the performance data of a database. To identify the most influential SQL statements, each SQL statement is analyzed by its SQL skeleton. The performance factors of SQL executions are accumulated by the SQL skeleton to highlight the most influential SQL statement through statistical analysis.

Apart from the RDBMS territory, the Convergence technique is applicable to any other domain that handles tremendous amount of similar data patterns and is not limited to SQL statements for diagnostics and analysis. This methodology is especially useful where it is humanly impossible to sift through large data patterns such as records from Human Resource departments, data warehouses, or stores that carry huge inventories. The normalization technique can be used to reduce similar data streams to simplified patterns while the Convergence technique can be used for even simple tasks such as calculating the frequency of occurrence of a specific data pattern. The invention must, however be customized according to the field of application as deemed necessary.

While the invention has been described in the preferred embodiments, it is understood that the words, which have been used, are words of description rather than words of limitation and that changes within the purview of the appended claims may be made without departing from the scope and spirit of the invention in its broader aspect.

What is claimed is:

1. A method for converging a plurality of Structured Query Language (SQL) statements into SQL skeletons to enhance database performance analysis and tuning by identifying the most influential SQL skeletons for databases on an relational database management system (RDBMS) platform, said method comprises the steps of:
(a) recording a plurality of SQL statements containing a plurality of variable strings and a plurality of performance factors from the RDBMS platform at predetermined time intervals;
(b) normalizing the plurality of SQL statements to extract the plurality of SQL skeletons corresponding to each SQL statement;
(c) inserting the plurality of SQL skeletons with the corresponding performance factors in a repository database;
(d) accumulating the plurality of performance factors corresponding to each SQL skeleton into the repository database; and
(e) generating a report containing a list of all SQL skeletons with the corresponding accumulated performance factors.

2. The method of claim 1, wherein the plurality of the accumulated performance factors is used for selection from the accumulated number of the plurality of SQL skeletons, namely average system resource cost of running the SQL statement per SQL skeleton, frequency of occurrence per SQL skeleton, and average of the number of rows returned for running the SQL statement.

3. The method of claim 2, wherein the most influential SQL skeleton is the one selected from the accumulated number of the plurality of SQL skeletons with maximum frequency of occurrence.

4. The method of claim 1, wherein step (b) further comprises the steps of:
(b1) stripping out the plurality of variable strings and/or constant from each SQL statement;
(b2) converting tabs and/or carriage return to space for each SQL statement;
(b3) removing extra white space for each SQL statement;
(b4) adding space around mathematical operators for each SQL statement; and
(b5) making all characters to lowercase characters for each SQL statement.

5. The method of claim 1, said method further comprises the steps of:
(c1) generating a Unique Signature Identifier for each of the plurality of SQL skeletons;
(c2) judging whether the Unique Signature Identifier is present in a Signature Container; and
(c3) if NO in step (c2), inserting the Unique Signature Identifier into the Signature Container and inserting the plurality of SQL skeletons with the corresponding performance factors in a repository database.

6. The method of claim 1, said method further comprises the steps of:
(c1) generating a Unique Signature Identifier for each of the plurality of SQL skeletons;
(c2) judging whether the Unique Signature Identifier is present in a Signature Container; and
(c3) if YES in step (c2), accumulating the plurality of performance factors for the previously inserted plurality of SQL skeletons into the repository database.
